(19) United States
(12) Patent Application Publication
(10) Pub. No.: US 2025/0365606 A1
(43) Pub. Date: Nov. 27, 2025

(54) Access point apparatus and access point communication method thereof having dynamic channel selection mechanism

(71) Applicant: REALTEK SEMICONDUCTOR CORPORATION, HSINCHU (TW)

(72) Inventor: TUNG-CHENG WU, Hsinchu (TW)

(21) Appl. No.: 19/214,159

(22) Filed: May 21, 2025

(30) Foreign Application Priority Data
May 23, 2024 (TW) 113119193

(51) Int. Cl. H04W 28/02; H04W 88/08

(52) U.S. Cl. CPC H04W 28/0231; H04W 28/0252; H04W 88/08

(57) ABSTRACT

The present disclosure discloses an access point communication method having dynamic channel selection mechanism used in an access point apparatus that includes steps outlined below. A wireless communication is performed with a station apparatus through a neighboring relay access point apparatus. Communication parameters related to the wireless communication are collected periodically. A required data flow amount of the station apparatus is calculated according to the communication parameters and available data flow amounts of wireless channels between the access point apparatus and the relay access point apparatus are calculated. Ratios between the required data flow amount and the available data flow amounts are calculated as channel crowding parameters. One of the wireless channels corresponding to one of the channel crowding parameters having a smallest value is selected to be a selected wireless channel to perform packet transmission to the station apparatus through the relay access point apparatus.

### BACKGROUND OF THE INVENTION

### 1. Field of the Invention

The present disclosure relates to an access point apparatus and an access point communication method thereof having dynamic channel selection mechanism.

### 2. Description of Related Art

The usage of mesh network based on WiFi technology becomes mature in recent years. The mesh network can be formed by a plurality of access point apparatuses and a plurality of station apparatuses. One or more than one links can be established between the access point apparatuses through the wireless channels and at least one of the access point apparatuses can be coupled to an external network, e.g., a wide area network (WAN). As a result, the access point apparatus coupled to the external network (e.g., WAN) may transmit the packet to the station apparatuses through other access point apparatuses serving as relays.

When the packet transmission is performed, the access point apparatus typically selects the wireless channel having the higher transmission rate. However, such a method does not allow the packet transmission to be performed based on an instant data transmission condition of the wireless channels. The transmission efficiency may degrade under the condition that the wireless channels are overcrowded.

### SUMMARY OF THE INVENTION

In consideration of the problem of the prior art, an object of the present disclosure is to provide an access point apparatus and an access point communication method thereof having dynamic channel selection mechanism.

The present invention discloses an access point apparatus having a dynamic channel selection mechanism that includes a communication circuit and a processing circuit. The communication circuit is configured to perform a wireless communication with a station apparatus through a relay access point apparatus neighboring thereto. The processing circuit is electrically coupled to the communication circuit and is configured to perform steps outlined below. A plurality of communication parameters related to the wireless communication are periodically collected through the communication circuit. According to the communication parameters, a required data flow amount of the station apparatus is calculated and a plurality of available data flow amounts of a plurality of wireless channels between the access point apparatus and the relay access point apparatus are calculated. A plurality of ratios each between the required data flow amount and one of the available data flow amounts are calculated as a plurality of channel crowding parameters that the wireless channels correspond to. One of the wireless channels corresponding to one of the channel crowding parameters having a smallest value is selected to be a selected wireless channel such that the communication circuit performs a packet transmission with the station apparatus through the relay access point apparatus.

The present invention also discloses an access point communication method having a dynamic channel selection mechanism used in an access point apparatus that includes steps outlined below. A wireless communication is performed with a station apparatus through a relay access point apparatus neighboring to the access point apparatus. A plurality of communication parameters related to the wireless communication are periodically collected through the communication circuit. According to the communication parameters, a required data flow amount of the station apparatus is calculated and a plurality of available data flow amounts of a plurality of wireless channels between the access point apparatus and the relay access point apparatus are calculated. A plurality of ratios each between the required data flow amount and one of the available data flow amounts are calculated as a plurality of channel crowding parameters that the wireless channels correspond to. One of the wireless channels corresponding to one of the channel crowding parameters having a smallest value is selected to be a selected wireless channel such that the communication circuit performs a packet transmission with the station apparatus through the relay access point apparatus.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a block diagram of a communication system according to an embodiment of the present invention.

FIG. 2 illustrates a flow chart of an access point communication method having a dynamic channel selection mechanism according to an embodiment of the present invention.

### DETAILED DESCRIPTION OF THE PREFERRED EMBODIMENTS

An aspect of the present invention is to provide an access point apparatus and an access point communication method thereof having dynamic channel selection mechanism to periodically collect communication parameters and calculate channel crowding parameters accordingly, so as to select a better wireless channel according to the channel crowding parameters to perform a packet transmission to increase the communication efficiency of the access point apparatus.

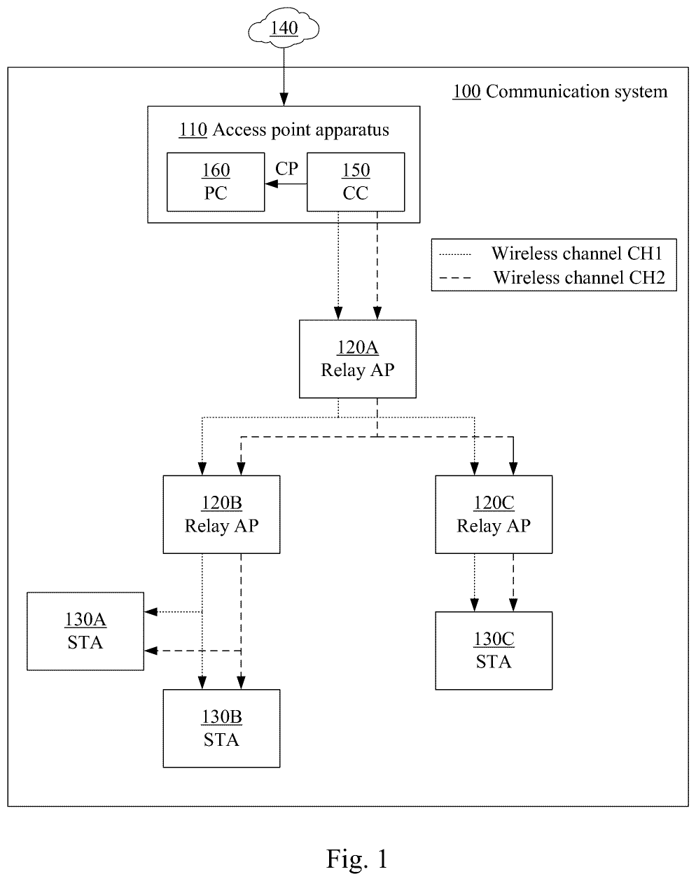

Reference is now made to FIG. 1. FIG. 1 illustrates a block diagram of a communication system 100 according to an embodiment of the present invention. The communication system 100 includes an access point apparatus 110, relay access point apparatuses 120A-120C (each abbreviated as Relay AP in FIG. 1) and station apparatuses 130A-130C (each abbreviated as STA in FIG. 1).

The access point apparatus 110, the relay access point apparatuses 120A-120C and the station apparatuses 130A-130C may form a network of such as, but not limited to a mesh network to perform communication with each other in a wireless form. In the present embodiment, the access point apparatus 110 is further configured to perform communication with an external network 140 that is such as a wide area network (WAN).

Other apparatuses in the mesh network, such as the relay access point apparatuses 120A-120C and the station apparatuses 130A-130C, can receive packets from the external network 140 through the access point apparatus 110 and transmit packets to the external network 140 through the access point apparatus 110.

The access point apparatus 110 includes a communication circuit 150 (abbreviated as CC in FIG. 1) and a processing circuit 160 (abbreviated as PC in FIG. 1).

The communication circuit 150 is configured to perform a wireless communication with a station apparatus through a relay access point apparatus neighboring thereto. It is appreciated that the term “neighboring” refers to the condition that such a relay access point apparatus is within a range of a predetermined distance around the access point apparatus 110 and is not necessarily physically coupled to the access point apparatus 110. The processing circuit 160 is electrically coupled to the communication circuit 150. In an embodiment, the processing circuit 160 may access and operate software/firmware from a memory (not illustrated in FIG. 1) further included by the access point apparatus 110, to control the communication circuit 150 to perform the wireless communication described above.

In the present embodiment, the neighboring relay access point apparatus is the relay access point apparatus 120A, and the communication circuit 150 can perform the wireless communication with the station apparatuses 130A-130C through the relay access point apparatus 120A.

In an embodiment, other relay access point apparatuses may be presented between the relay access point apparatus 120A and the station apparatuses 130A-130C. For example, the relay access point apparatus 120A may be wirelessly coupled to the station apparatuses 130A and 130B through the relay access point apparatus 120B such that the communication circuit 150 performs the wireless communication with the station apparatuses 130A and 130B through a path including the relay access point apparatus 120A and the relay access point apparatus 120B. On the other hand, the relay access point apparatus 120A may be wirelessly coupled to the station apparatus 130C through the relay access point apparatus 120C such that the communication circuit 150 performs the wireless communication with the station apparatus 130C through a path including the relay access point apparatus 120A and the relay access point apparatus 120C.

However, under the condition that the distance is close enough or the signal strength is strong enough, the relay access point apparatus 120A may selectively be wirelessly coupled to the station apparatuses 130A-130C directly without the presence of any relay access point apparatus such that the communication circuit 150 performs the wireless communication with the station apparatuses 130A-130C through only the relay access point apparatus 120A. The present invention is not limited to a certain network connection configuration. In short, the description of “the access point apparatus 110 performs the wireless communication with the station apparatuses 130A-130C” in the following paragraphs may occur either under the condition that none of the relay access point apparatus is presented between the relay access point apparatus 120A and the station apparatuses 130A-130C or under the condition that at least one relay access point apparatus is presented between the relay access point apparatus 120A and the station apparatuses 130A-130C.

The mesh network formed by the access point apparatus 110, the relay access point apparatuses 120A-120C and the station apparatuses 130A-130C includes a plurality of wireless channels for performing communication, e.g., a wireless channel CH1 illustrated by a dotted line and a wireless channel CH2 illustrated as a dashed line in FIG. 1. It is appreciated that the number of the wireless channels illustrated in FIG. 1 is merely an example. The present invention is not limited thereto.

In an embodiment, when the access point apparatus 110 and the relay access point apparatus 120A allow a multi-backhaul communication to be performed, the wireless channel CH1 and the wireless channel CH2 can be a plurality of links established between the access point apparatus 110 and the relay access point apparatus 120A after such as, but not limited to a handshake process is performed. Other wireless channels that are not links established therebetween may exist between the access point apparatus 110 and the relay access point apparatus 120A. The present invention is not limited thereto.

The access point apparatus 110 selects one of the wireless channel CH1 and the wireless channel CH2 established to be the links to perform the wireless communication with the station apparatus through the neighboring relay access point apparatus. However, according to the different communication conditions among the apparatuses in the mesh network, the wireless channel CH1 and the wireless channel CH2 have different degrees of crowdedness. In order to increase the communication efficiency of the wireless communication performed by the access point apparatus 110, the access point apparatus 110 is equipped with a dynamic channel selection mechanism to select the better wireless channel to perform the wireless communication according to the operation of the processing circuit 160.

The condition that the access point apparatus 110 performs the wireless communication with the station apparatus 130A through the relay access point apparatus 120A is used as an example to elaborate the dynamic channel selection mechanism of the access point apparatus 110.

At first, the processing circuit 160 periodically collects a plurality of communication parameters CP related to the wireless communication performed by the relay access point apparatus 120A and the station apparatus 130A through the communication circuit 150.

In an embodiment, the communication parameters CP include a physical transmission rate of each of the wireless channel CH1 and the wireless channel CH2, a station apparatus data rate of the station apparatus 130A, a first channel usage rate of each of the wireless channel CH1 and the wireless channel CH2 measured by the access point apparatus 110 and a second channel usage rate of each of the wireless channel CH1 and the wireless channel CH2 measured by the relay access point apparatus 120A.

The physical transmission rate of each of the wireless channel CH1 and the wireless channel CH2 includes an actual physical transmission rate. In an embodiment, the processing circuit 160 may measure the data transmission amount of each of the wireless channel CH1 and the wireless channel CH2 and the time through the communication circuit 150 to document the actual physical transmission rate thereof.

The station apparatus data rate of the station apparatus 130A is the rate of the data transmission performed by the station apparatus 130A through the access point apparatus 110.

In an embodiment, the processing circuit 160 may identify the data transmission corresponding to the station apparatus 130A according to the identification information of such as, but not limited to the media access control (MAC) address of packets transmitted through the access point apparatus 110 by using the communication circuit 150. The processing circuit 160 further measures the data transmission amount of the station apparatus 130A and the time to document the station apparatus data rate of the station apparatus 130A.

The first channel usage rate of each of the wireless channel CH1 and the wireless channel CH2 measured by the access point apparatus 110 and the second channel usage rate of each of the wireless channel CH1 and the wireless channel CH2 measured by the relay access point apparatus 120A are respectively in the form of percentage. In the mesh network, the apparatus physically close to the access point apparatus 110 (e.g., only the relay access point apparatus 120A) and the apparatuses physically close to the relay access point apparatus 120A (e.g., the access point apparatus 110, the relay access point apparatus 120B and the relay access point apparatus 120C) are different. As a result, the channel usages measured by the access point apparatus 110 and the relay access point apparatus 120A can be different.

According to the communication parameters CP described above, the processing circuit 160 calculates a required data flow amount of the station apparatus 130A and calculates available data flow amounts that the wireless channel CH1 and the wireless channel CH2 between the access point apparatus 110 and the relay access point apparatus 120A correspond to.

In an embodiment, the required data flow amount is the station apparatus data rate and is represented by DR.

In an embodiment, any one of the available data flow amounts is a product of a channel idle rate of a corresponding wireless channel in the wireless channel CH1 and the wireless channel CH2 and the physical transmission rate of the corresponding wireless channel. The channel idle rate is a complement of a larger one of the first channel usage rate and the second channel usage rate of the corresponding wireless channel.

In an embodiment, an available data flow amount is represented by SR, the first channel usage rate is represented by CUA, the second channel usage rate is represented by CUB, and the physical transmission rate is the actual physical transmission rate and is represented by PR. Under such a condition, the larger one of first channel usage rate and the second channel usage rate is represented by Max(CUA, CUB), and the channel idle rate is the corresponding complement 1−Max(CUA, CUB). The available data flow amount is derived from the equation below:

$$S R = ( 1 - Max ( C UA , CUB ) ) \times P R \qquad ( equation 1 )$$

When the available data flow amount of the wireless channel CH1 is represented by SR₁, the actual physical transmission rate of the wireless channel CH1 is represented by PR₁, the first channel usage rate of the wireless channel CH1 is represented by CUA₁, and the second channel usage rate of the wireless channel CH1 is represented by CUB₁, the available data flow amount SR₁ is calculated by the product of the channel idle rate of the wireless channel CH1 and the actual physical transmission rate PR₁ of the wireless channel CH1 and is derived from (equation 1) to become:

$$S {R}_{1} = ( 1 - Max ( C U {A}_{1} , CU {B}_{1} ) ) \times P {R}_{1} \qquad ( equation 2 )$$

When the available data flow amount of the wireless channel CH2 is represented by SR₂, the actual physical transmission rate of the wireless channel CH2 is represented by PR₂, the first channel usage rate of the wireless channel CH2 is represented by CUA₂, and the second channel usage rate of the wireless channel CH2 is represented by CUB₂, the available data flow amount SR₂ is calculated by the product of the channel idle rate of the the wireless channel CH2 and the actual physical transmission rate PR₂ of the wireless channel CH2 and is derived from (equation 1) to become:

$$S {R}_{2} = ( 1 - Max ( C U {A}_{2} , CU {B}_{2} ) ) \times P {R}_{2} \qquad ( equation 3 )$$

The processing circuit 160 further calculates a plurality of ratios each between the required data flow amount and one of the available data flow amounts as a plurality of channel crowding parameters that the wireless channels correspond to.

In an embodiment, a channel crowding parameter is represented by CC. According to the required data flow amount DR and the available data flow amount SR calculated from (equation 1), the channel crowding parameter CC is represented by the equation below:

$$C C = DR / SR = DR / ( ( 1 - Max ( C UA , CUB ) ) \times P R ) \qquad ( equation 4 )$$

As a result, the channel crowding parameter of the wireless channel CH1 is represented by CC₁ and is the ratio between the required data flow amount DR and the available data flow amount SR₁ of the wireless channel CH1 such that the (equation 4) is modified according to (equation 2) to become:

$$C {C}_{1} = DR / {SR}_{1} = DR / ( ( 1 - Max ( C U {A}_{1} , CU {B}_{1} ) ) \times P {R}_{1} ) \qquad ( equation 5 )$$

The channel crowding parameter of the wireless channel CH2 is represented by CC₂ and is the ratio between the required data flow amount DR and the available data flow amount SR₂ of the wireless channel CH2 such that the (equation 4) is modified according to (equation 3) to become:

$$C {C}_{2} = DR / {SR}_{2} = DR / ( ( 1 - Max ( C U {A}_{2} , CU {B}_{2} ) ) \times P {R}_{2} ) \qquad ( equation 6 )$$

In a numerical example, the required data flow amount DR is 200 Mbps, the actual physical transmission rate PR₁ of the wireless channel CH1 is 1201 Mbps, the first channel usage rate CUA₁ of the wireless channel CH1 is 10%, and the second channel usage rate CUB₁ of the wireless channel CH1 is 60%, the channel crowding parameter CC₁ of the wireless channel CH1 is calculated according to (equation 5):

$$C {C}_{1} = 200 / ( ( 1 - Max ( 10 \% , 60 \% ) ) \times 1201 ) = 0.42$$

When the actual physical transmission rate PR₂ of the wireless channel CH2 is 980 Mbps, the first channel usage rate CUA₂ of the wireless channel CH2 is 10%, and the second channel usage rate CUB₂ of the wireless channel CH2 is 60%, the channel crowding parameter CC₂ of the wireless channel CH2 is calculated according to (equation 6):

$$C {C}_{2} = 200 / ( ( 1 - Max ( 5 \% , 2 \% ) ) \times 980 ) = 0.22$$

The processing circuit 160 one of the wireless channels corresponding to one of the channel crowding parameters having a smallest value to be a selected wireless channel such that the communication circuit 150 performs a packet transmission with the station apparatus 130A through the relay access point apparatus 120A.

According to the numerical example described above, the processing circuit 160 determines that the smallest value of the channel crowding parameter CC₁ of the wireless channel CH1 and the channel crowding parameter CC₂ of the wireless channel CH2 is the channel crowding parameter CC₂. As a result, even the wireless channel CH1 has a larger actual physical transmission rate PR₁ (1201 Mbps), the processing circuit 160 still selects the wireless channel CH2 with the smaller actual physical transmission rate PR₂ (980 Mbps) but corresponding to the channel crowding parameter CC₂ to be the selected wireless channel to perform the packet transmission.

In an embodiment, the physical transmission rate of the communication parameters CP further includes a maximum physical rate and is represented by MPR. The processing circuit 160 is further configured to determine that at least two of the channel crowding parameters have the smallest value and correspond to a plurality of under-selection wireless channels of the wireless channels, so as to select one of the under-selection wireless channels having the largest maximum physical rate to be the selected wireless channel to perform the packet transmission.

For example, when the processing circuit 160 determines that the channel crowding parameter CC₁ of the wireless channel CH1 and the channel crowding parameter CC₂ of the wireless channel CH2 both have the smallest value, the processing circuit 160 considers that the degree of the crowdedness of the wireless channel CH1 and the wireless channel CH2 are the same and both of the wireless channel CH1 and the wireless channel CH2 are the under-selection wireless channels. When the maximum physical rate of the wireless channel CH1 is represented by MPR₁ and the maximum physical rate of the wireless channel CH2 is represented by MPR₂, and the maximum physical rate MPR₁ of the wireless channel CH1 is larger than the maximum physical rate MPR₂ of the wireless channel CH2, the processing circuit 160 selects the wireless channel CH1 to be the selected wireless channel to perform the packet transmission.

When both of the under-selection wireless channels have the same maximum physical rate, the processing circuit 160 randomly selects one of the under-selection wireless channels to be the selected wireless channel to perform the packet transmission. For example, when the channel crowding parameter CC₁ of the wireless channel CH1 and the channel crowding parameter CC₂ of the wireless channel CH2 have the same smallest value and the maximum physical rate of the wireless channel CH1 and the maximum physical rate of the wireless channel CH2 are the same as well, the processing circuit 160 randomly selects one of the wireless channel CH1 and the wireless channel CH2 to be the selected wireless channel to perform the packet transmission.

It is appreciated that the method that generates the channel crowding parameter CC₁ and channel crowding parameter CC₂ based on the calculation of the (equation 5) and (equation 6) needs to be modified by setting additional constraints in some specific usage scenarios.

For example, when no data transmission is performed by the station apparatus 130A in a certain amount of time such that the station apparatus data rate is 0, the processing circuit 160 may set the station apparatus data rate to be 1 to calculate the ratio between the required data flow amount and the available data flow amount to avoid the numerator in (equation 5) and (equation 6) becomes 0, in which both of the channel crowding parameter CC₁ and the channel crowding parameter CC₂ become 0 due to the numerator that is 0.

Besides, when one of wireless channels, e.g., the larger one of the first channel usage rate CUA₁ and the second channel usage rate CUB₁ of the wireless channel CH1 is 100%, the processing circuit 160 does not select the wireless channel CH1. By using such a method, the processing circuit 160 not only avoids the generation of an infinite large channel crowding parameter CC₁ due to the denominator in equation 5) and (equation 6) that is 0, but also directly neglects the wireless channel CH1 that is overcrowded due to the channel usage rate that is 100%.

However, when the larger one of the first channel usage rate and the second channel usage rate of each of the wireless channels is 100%, e.g., the condition that the larger one of the first channel usage rate CUA₁ and second channel usage rate CUB₁ of the wireless channel CH1 is 100% and the larger one of the first channel usage rate CUA₂ and the second channel usage rate CUB₂ of the wireless channel CH2 is also 100%, the processing circuit 160 considers that both of the wireless channel CH1 and the wireless channel CH2 are overcrowded and randomly selects one of the wireless channels to be the selected wireless channel to perform the packet transmission.

The embodiments above are described based on the condition that the access point apparatus 110 and the relay access point apparatus 120A allow the multi-backhaul communication to be performed. In another embodiment, when the access point apparatus 110 and the relay access point apparatus 120A only allow a single-backhaul communication to be performed, only one of the wireless channels is allowed to establish a link between the access point apparatus 110 and the relay access point apparatus 120A.

Under such a condition, only one of the wireless channel CH1 and the wireless channel CH2 in FIG. 1 is allowed to establish the link to perform the actual data transmission. The processing circuit 160 cannot calculate the actual physical transmission rate included in the physical transmission rate through the communication circuit 150. Under such a condition, the processing circuit 160 may replace the actual physical transmission rate PR₁ by the maximum physical rate MPR₁ of the wireless channel CH1 and modify (equation 5) to become:

$$C {C}_{1} = DR / {SR}_{1} = DR / ( ( 1 - Max ( C U {A}_{1} , CU {B}_{1} ) ) \times M P {R}_{1} ) \qquad ( equation 7 )$$

On the other hand, the processing circuit 160 may replace the actual physical transmission rate PR₂ by the maximum physical rate MPR₂ of the wireless channel CH2 and modify (equation 6) to become:

$$C {C}_{2} = DR / {SR}_{2} = DR / ( ( 1 - Max ( C U {A}_{2} , CU {B}_{2} ) ) \times M P {R}_{2} ) \qquad ( equation 8 )$$

According to (equation 7) and (equation 8), the processing circuit 160 may calculate the channel crowding parameter CC₁ of the wireless channel CH1 and the channel crowding parameter CC₂ of the wireless channel CH2 under the condition that the access point apparatus 110 and the relay access point apparatus 120A only allow the single-backhaul communication to be performed. The processing circuit 160 further selects one of the wireless channels that one of the channel crowding parameters having the smallest value corresponds to be the selected wireless channel, such that the communication circuit 150 performs the packet transmission with the station apparatus 130A through the relay access point apparatus 120A accordingly.

Similarly, the method that generates the channel crowding parameter CC₁ and the channel crowding parameter CC₂ based on the calculation of (equation 7) and (equation 8) needs to be modified by setting additional constraints in some specific usage scenarios. More specifically, when the station apparatus data rate of the station apparatus 130A is 0, the processing circuit 160 may set the station apparatus data rate to be 1 to calculate the ratio between the required data flow amount and the available data flow amount. When the larger one of the channel usage rates of any one of the wireless channels is 100%, the processing circuit 160 does not select such a wireless channel. Moreover, when the larger one of the first channel usage rate and the second channel usage rate of each of the wireless channels is 100%, the processing circuit 160 randomly selects one of the wireless channels to be the selected wireless channel toe perform the packet transmission with the station apparatus 130A through the relay access point apparatus 120A.

The detail of the determination of the selected wireless channel under the condition that the access point apparatus 110 and the relay access point apparatus 120A only allow the single-backhaul communication to be performed and the determination of the selected wireless channel under the condition that the access point apparatus 110 and the relay access point apparatus 120A allow the multi-backhaul communication to be performed executed by the processing circuit 160 are identical. As a result, the detail thereof is not described herein.

The dynamic channel selection mechanism of the wireless communication performed with the station apparatus 130A through the relay access point apparatus 120A executed by the processing circuit 160 can be applied to the wireless communication performed with the station apparatus 130B through the relay access point apparatus 120A and the wireless communication performed with the station apparatus 130C through the relay access point apparatus 120B. The detail is not described herein.

In some approaches, when the access point apparatus performs the wireless communication with the station apparatus through the relay access point apparatus, one of the wireless channels having the highest transmission rate is selected to perform the packet transmission. However, such a method does not allow the packet transmission to be performed according to an instant data transmission condition of the wireless channels. The transmission efficiency may degrade under the condition that the wireless channels are overcrowded.

The access point apparatus having a dynamic channel selection mechanism of the present invention periodically collects communication parameters and calculates channel crowding parameters accordingly, so as to select a better wireless channel according to the channel crowding parameters to perform a packet transmission to increase the communication efficiency of the access point apparatus.

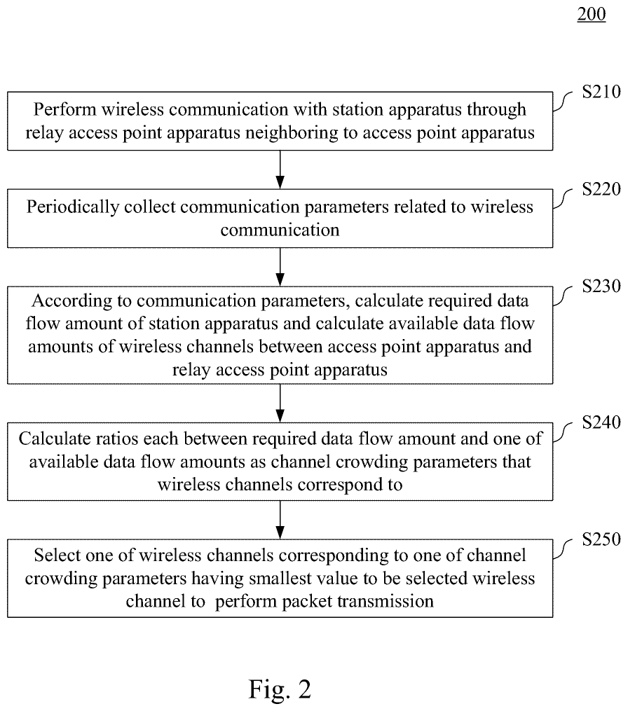

Reference is now made to FIG. 2. FIG. 2 illustrates a flow chart of an access point communication method 200 having a dynamic channel selection mechanism according to an embodiment of the present invention.

Besides the apparatus described above, the present invention further discloses the access point communication method 200 having the dynamic channel selection mechanism that can be used in such as, but not limited to the access point apparatus 110 illustrated in FIG. 1. An embodiment of the access point communication method 200 is illustrated in FIG. 2 and includes the steps outlined below.

In step S210, a wireless communication is performed with a station apparatus through a relay access point apparatus neighboring to the access point apparatus.

For example, the wireless communication is performed by the access point apparatus 110 with the station apparatus 130A through the relay access point apparatus 120A in FIG. 1.

In step S220, a plurality of communication parameters related to the wireless communication are periodically collected through the communication circuit.

For example, the communication parameters CP related to the wireless communication are periodically collected through the communication circuit 150 by the processing circuit 160 of the access point apparatus 110 in FIG. 1.

In step S230, according to the communication parameters, a required data flow amount of the station apparatus is calculated and a plurality of available data flow amounts of a plurality of wireless channels between the access point apparatus and the relay access point apparatus are calculated.

For example, according to the communication parameters CP, the required data flow amount DR of the station apparatus 130A is calculated and the available data flow amounts SR₁˜SR₂ of the wireless channels CH1˜CH2 between the access point apparatus 110 and the relay access point apparatus 120A are calculated by the processing circuit 160 of the access point apparatus 110 in FIG. 1.

In step S240, a plurality of ratios each between the required data flow amount and one of the available data flow amounts are calculated as a plurality of channel crowding parameters that the wireless channels correspond to.

For example, the ratios between the required data flow amount DR and the available data flow amounts SR₁˜SR₂ of the wireless channel CH1˜CH2 are calculated as the channel crowding parameters CC₁˜CC₂ that the wireless channel CH1˜CH2 correspond to by the processing circuit 160 of the access point apparatus 110 in FIG. 1.

In step S250, one of the wireless channels corresponding to one of the channel crowding parameters having a smallest value is selected to be a selected wireless channel such that the communication circuit performs a packet transmission with the station apparatus through the relay access point apparatus.

For example, the wireless channel CH1 corresponding to the channel crowding parameter CC₁ having the smallest value is selected to be the selected wireless channel to perform the packet transmission by the processing circuit 160 of the access point apparatus 110 in FIG. 1.

It is appreciated that the embodiments described above are merely an example. In other embodiments, it is appreciated that many modifications and changes may be made by those of ordinary skill in the art without departing, from the spirit of the invention.

For example, the configuration of the mesh network in FIG. 1 is merely an example. In other embodiments, the mesh network may include other configurations and include different numbers of relay access point apparatuses and station apparatuses. The dynamic channel selection mechanism can be applied to the mesh network with different configurations. The present invention is not limited to the embodiment in FIG. 1.

Further, the number and the type of the communication parameters and the calculation method of the channel crowding parameters described above are merely an example. In other embodiments, the processing circuit may collect other numbers and types of communication parameters and generate the channel crowding parameters according to other calculation methods based on the collected communication parameters to further select the selected wireless channel according to the channel crowding parameters.

In summary, the access point apparatus and the access point communication method thereof having dynamic channel selection mechanism periodically collect communication parameters and calculate channel crowding parameters accordingly, so as to select a better wireless channel according to the channel crowding parameters to perform a packet transmission to increase the communication efficiency of the access point apparatus.

The aforementioned descriptions represent merely the preferred embodiments of the present disclosure, without any intention to limit the scope of the present disclosure thereto. Various equivalent changes, alterations, or modifications based on the claims of present disclosure are all consequently viewed as being embraced by the scope of the present disclosure.

What is claimed is:

1. An access point apparatus having a dynamic channel selection mechanism comprising:
a communication circuit configured to perform a wireless communication with a station apparatus through a relay access point apparatus neighboring thereto; and
a processing circuit electrically coupled to the communication circuit and configured to:
periodically collect a plurality of communication parameters related to the wireless communication through the communication circuit;
according to the communication parameters, calculate a required data flow amount of the station apparatus and calculate a plurality of available data flow amounts of a plurality of wireless channels between the access point apparatus and the relay access point apparatus;
calculate a plurality of ratios each between the required data flow amount and one of the available data flow amounts as a plurality of channel crowding parameters that the wireless channels correspond to; and
select one of the wireless channels corresponding to one of the channel crowding parameters having a smallest value to be a selected wireless channel such that the communication circuit performs a packet transmission with the station apparatus through the relay access point apparatus.

2. The access point apparatus of claim 1, wherein the communication parameters comprise a physical transmission rate of each of the wireless channels, a station apparatus data rate of the station apparatus, a first channel usage rate of each of the wireless channels measured by the access point apparatus and a second channel usage rate of each of the wireless channels measured by the relay access point apparatus;
the required data flow amount is the station apparatus data rate, any one of the available data flow amounts is a product of a channel idle rate of a corresponding wireless channel in the wireless channels and the physical transmission rate of the corresponding wireless channel, and the channel idle rate is a complement of a larger one of the first channel usage rate and the second channel usage rate of the corresponding wireless channel.

3. The access point apparatus of claim 2, wherein when the access point apparatus and the relay access point apparatus allow a multi-backhaul communication to be performed, the wireless channels are a plurality of links established between the access point apparatus and the relay access point apparatus, and the physical transmission rate of each of the wireless channels comprises an actual physical transmission rate such that the available data flow amounts are calculated according to the actual physical transmission rate.

4. The access point apparatus of claim 3, wherein the physical transmission rate of each of the wireless channels further comprises a maximum physical rate, and the processing circuit is further configured to:
determine that at least two of the channel crowding parameters have the smallest value and correspond to a plurality of under-selection wireless channels of the wireless channels;
select one of the under-selection wireless channels having the largest maximum physical rate to be the selected wireless channel to perform the packet transmission; and
randomly select one of the under-selection wireless channels to be the selected wireless channel to perform the packet transmission when the under-selection wireless channels have the same maximum physical rate.

5. The access point apparatus of claim 2, wherein when the access point apparatus and the relay access point apparatus only allow a single-backhaul communication to be performed, only one of the wireless channels is allowed to establish a link between the access point apparatus and the relay access point apparatus and the physical transmission rate that each of wireless channels comprises comprises a maximum physical rate.

6. The access point apparatus of claim 5, wherein the processing circuit is further configured to:
determine that at least two of the channel crowding parameters have the smallest value and correspond to a plurality of under-selection wireless channels of the wireless channels;
select one of the under-selection wireless channels having the largest maximum physical rate to be the selected wireless channel to perform the packet transmission; and
randomly select one of the under-selection wireless channels to be the selected wireless channel to perform the packet transmission when the under-selection wireless channels have the same maximum physical rate.

7. The access point apparatus of claim 2, wherein the processing circuit is configured to:
set the station apparatus data rate to be 1 to calculate the ratios when the station apparatus data rate of the station apparatus is 0.

8. The access point apparatus of claim 2, wherein the processing circuit is configured to:
not select the corresponding wireless channel when a larger one of the first channel usage rate and the second channel usage rate of the corresponding wireless channel is 100%; and
randomly select one of the wireless channels to be the selected wireless channel to perform the packet transmission when the larger one of the first channel usage rate and the second channel usage rate of each of the wireless channels is 100%.

9. An access point communication method having a dynamic channel selection mechanism used in an access point apparatus, comprising:
performing a wireless communication with a station apparatus through a relay access point apparatus neighboring to the access point apparatus;
periodically collecting a plurality of communication parameters related to the wireless communication;
according to the communication parameters, calculating a required data flow amount of the station apparatus and calculating a plurality of available data flow amounts of a plurality of wireless channels between the access point apparatus and the relay access point apparatus;
calculating a plurality of ratios each between the required data flow amount and one of the available data flow amounts as a plurality of channel crowding parameters that the wireless channels correspond to; and
selecting one of the wireless channels corresponding to one of the channel crowding parameters having a smallest value to be a selected wireless channel such that the packet transmission is performed with the station apparatus through the relay access point apparatus.

10. The access point communication method of claim 9, wherein the communication parameters comprise a physical transmission rate of each of the wireless channels, a station apparatus data rate of the station apparatus, a first channel usage rate of each of the wireless channels measured by the access point apparatus and a second channel usage rate of each of the wireless channels measured by the relay access point apparatus;
the required data flow amount is the station apparatus data rate, any one of the available data flow amounts is a product of a channel idle rate of a corresponding wireless channel in the wireless channels and the physical transmission rate of the corresponding wireless channel, and the channel idle rate is a complement of a larger one of the first channel usage rate and the second channel usage rate of the corresponding wireless channel.

11. The access point communication method of claim 10, wherein when the access point apparatus and the relay access point apparatus allow a multi-backhaul communication to be performed, the wireless channels are a plurality of links established between the access point apparatus and the relay access point apparatus, and the physical transmission rate of each of the wireless channels comprises an actual physical transmission rate such that the available data flow amounts are calculated according to the actual physical transmission rate.

12. The access point communication method of claim 11, wherein the physical transmission rate of each of the wireless channels further comprises a maximum physical rate, and the access point communication method further comprises:
determining that at least two of the channel crowding parameters have the smallest value and correspond to a plurality of under-selection wireless channels of the wireless channels;
selecting one of the under-selection wireless channels having the largest maximum physical rate to be the selected wireless channel to perform the packet transmission; and
randomly selecting one of the under-selection wireless channels to be the selected wireless channel to perform the packet transmission when the under-selection wireless channels have the same maximum physical rate.

13. The access point communication method of claim 10, wherein when the access point apparatus and the relay access point apparatus only allow a single-backhaul communication to be performed, only one of the wireless channels is allowed to establish a link between the access point apparatus and the relay access point apparatus and the physical transmission rate, that each of wireless channels comprises, comprises a maximum physical rate.

14. The access point communication method of claim 13, further comprising:
determining that at least two of the channel crowding parameters have the smallest value and correspond to a plurality of under-selection wireless channels of the wireless channels;
selecting one of the under-selection wireless channels having the largest maximum physical rate to be the selected wireless channel to perform the packet transmission; and
randomly selecting one of the under-selection wireless channels to be the selected wireless channel to perform the packet transmission when the under-selection wireless channels have the same maximum physical rate.

15. The access point communication method of claim 10, further comprising:
setting the station apparatus data rate to be 1 to calculate the ratios when the station apparatus data rate of the station apparatus is 0.

16. The access point communication method of claim 10, further comprising:
not selecting the corresponding wireless channel when a larger one of the first channel usage rate and the second channel usage rate of the corresponding wireless channel is 100%; and
randomly selecting one of the wireless channels to be the selected wireless channel to perform the packet transmission when the larger one of the first channel usage rate and the second channel usage rate of each of the wireless channels is 100%.
